(19) United States
(12) Patent Application Publication
(10) Pub. No.: US 2009/0066217 A1
(43) Pub. Date: Mar. 12, 2009

(54) DISPLAY DEVICE HAVING A BACKLIGHT DEVICE

(76) Inventor: Sang-Hun Park, Yongin-si (KR)

Correspondence Address: CHRISTIE, PARKER & HALE, LLP, PO BOX 7068, PASADENA, CA, 91109-7068, US

(21) Appl. No.: 12/184,007

(22) Filed: Jul. 31, 2008

(30) Foreign Application Priority Data
Sep. 11, 2007 (KR) 10-2007-0092121

(51) Int. Cl. H01J 1/62

(52) U.S. Cl. 313/496

(57) ABSTRACT

A display device including a backlight device for shielding a lead wire connected to an anode electrode and stably connecting the lead wire and the anode connector. The display device includes a voltage applying unit for applying an anode voltage to the anode electrode of the backlight device. The voltage applying unit includes a lead wire that is connected to the anode electrode and partially exposed to the outside of a vacuum chamber, an insulation case for shielding the lead wire outside of the vacuum chamber, an elastic member in the insulation case to fix the insulation case to a vacuum chamber by using elastic force, and an anode connector extending through the insulation case to apply the anode voltage to the lead wire.

### CROSS-REFERENCE TO RELATED APPLICATION

This application claims priority to and the benefit of Korean Patent Application No. 10-2007-0092121, filed in the Korean Intellectual Property Office on Sep. 11, 2007, the entire content of which is incorporated herein by reference.

### BACKGROUND OF THE INVENTION

1. Field of the Invention

The present invention relates to a display device having a backlight device. More particularly, the present invention relates to a configuration for applying an anode voltage to an anode electrode of the backlight device.

2. Description of the Related Art

A backlight device includes an anode electrode and a phosphor layer that are disposed on a front substrate, and electron emission regions and driving electrodes that are disposed on a rear substrate. The front and rear substrates are attached and sealed to each other at their peripheries using a sealing member, and air is removed from the inner space between the front and rear substrates to form a vacuum chamber.

The electron emission regions emit electrons toward the phosphor layer, and the electrons excite the phosphor layer to emit visible light. Here, the anode electrode receives a high voltage (e.g., an anode voltage) from a power source unit to accelerate and direct an electron beam toward the phosphor layer to maintain the phosphor layer at a high potential. The power source unit is outside the vacuum chamber.

A conventional backlight device uses a lead wire to apply the anode voltage to the anode electrode. The lead wire goes through or across the sealing member. A terminal of the lead wire positioned inside the vacuum chamber is electrically connected to the anode electrode, and another terminal of the lead wire positioned outside of the vacuum chamber is electrically connected to the power source unit.

However, since a leakage current occurs at a part where the lead wire is exposed, it is required to shield the part.

Further, an anode button method for applying the anode voltage without using the lead wire has been disclosed. In the anode button method, a hole is formed on the front substrate in the sealing member, a metallic material anode button is positioned on the hole, and the anode button and the anode electrode are electrically connected on an inner surface of the front substrate to apply the anode voltage from outside of the front substrate through the anode button.

However, in this method, since stress occurs and remains on the front substrate around the anode button, a crack or a vacuum leakage may occur, and it is required to additionally perform a hole forming process and an anode button inserting process. Therefore, the manufacturing process thereof may be complicated, and the cost may increase.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a display device including a backlight device configured for shielding a lead wire exposed to the outside of a vacuum chamber of the backlight device and stably connecting the lead wire and a power source unit.

An exemplary embodiment of the present invention provides a display device. The display device includes a display for displaying an image and a backlight device for providing light toward the display panel. The backlight device includes a first substrate and a second substrate facing the first substrate, a sealing member, an electron emission unit on an inner surface of the first substrate, a light emission unit on an inner surface of the second substrate and including an anode electrode, and a voltage applying unit. The sealing member is between the first substrate and the second substrate. A space enclosed by the sealing member, the first substrate and the second substrate is a vacuum chamber. The voltage applying unit applies an anode voltage to the anode electrode. The voltage applying unit includes a lead wire connected to the anode electrode and partially outside the vacuum chamber, an insulation case for shielding a portion of the lead wire outside the vacuum chamber, an elastic member in the insulation case for securing the insulation case to the vacuum chamber by friction, and an anode connector connected to the insulation case for applying the anode voltage to the lead wire.

The display device may include an insulation mound, on the inner surface of the second substrate outside of the vacuum chamber, to deflect the lead wire toward the first substrate.

The anode connector and the lead wire may be electrically connected to each other by the elastic member.

The elastic member may include a first elastic portion for receiving a portion of the first substrate and contacting the anode connector, and a second elastic portion between the first and second substrates for contacting the lead wire.

The first elastic portion may include a first horizontal portion and a second horizontal portion in parallel to each other and a vertical portion for connecting the first horizontal portion and the second horizontal portion. A gap between the first horizontal portion and the second horizontal portion is configured to be less than a thickness of the first substrate before the first substrate is inserted into the gap. The second elastic portion may include a contact portion for contacting the lead wire and a connecting portion for connecting the contact portion to the first elastic portion, and the second elastic portion is configured to be compressed between the first and second substrates.

The insulation case may include a bottom portion, a pair of second side wall portions, and a guide portion. The bottom portion faces an outer surface of the first substrate, and a first side wall portion extends from an edge of the bottom portion to the second substrate. A pair of second side wall portions respectively extend from a left edge and a right edge of the first side wall portion to the sealing member, and a guide portion extends from an inner surface of the first side wall portion to the sealing member.

The first elastic portion may be between the bottom portion and the guide portion, and the first elastic portion may be secured to the insulation case.

The bottom portion may include an opening, and the anode connector extends through the opening to contact the vertical portion of the first elastic portion. The anode connector may contact the lead wire.

The elastic member may include a first supporting portion, a second supporting portion, an elastic portion, and an opening within the first supporting portion. The anode connector extends through the opening. The first supporting portion may contact the inner surface of the first substrate. The second supporting portion may contact the inner surface of the second substrate. The elastic portion may connect the first supporting portion and the second supporting portion.

The insulation case may include a bottom portion, a first side wall portion, a pair of second side wall portions, and a pair of facing guide portions. The bottom portion may partially face an outer surface of the first substrate and includes an opening. The anode connector extends through the opening. The first side wall portion may extend from an edge of the bottom portion to the second substrate. The pair of second side wall portions may extend from left and right edges of the first side wall portions to the sealing member. The pair of facing guide portions, one each on each of the second side wall portions, may be proximate to edges of the second side wall portions opposite to edges of the second said wall portions meeting the first side wall portion.

Each guide portions may include a first guide surface for contacting the inner surface of the first substrate and a second guide surface for contacting a side surface of the first substrate.

The first supporting portion may be between the pair of facing guide portions, and the first supporting portion may be configured to contact the inner surface of the first substrate when the first substrate is positioned between the pair of facing guide portions and the bottom portion.

The elastic member may include a first supporting portion, a pair of second supporting portions, and a pair of elastic portions. The first supporting portion contacts the inner surface of the first substrate. The pair of second supporting portions contact the inner surface of the second substrate and are positioned at a distance from each other. The pair of elastic portions connect the first supporting portion and the second supporting portions, wherein the first supporting portion includes an opening. The anode connector extends through the opening.

The display panel may include a plurality of first pixels. The backlight device may include a plurality of second pixels less in number than the plurality of first pixels, and the plurality of second pixels each are configured to emit light corresponding to a highest gray-level among gray-levels of the corresponding first pixels of the plurality of first pixels. The display panel may include a liquid crystal display panel.

### BRIEF DESCRIPTION OF THE DRAWINGS

FIG. 1 is a cross-sectional view of a backlight device according to a first exemplary embodiment of the present invention.

FIG. 2 is a partial exploded perspective view of the inside of an active area of the backlight device shown in FIG. 1.

FIG. 3 is an exploded perspective view of an insulation case and an elastic member shown in FIG. 1.

FIG. 4 is a cross-sectional view of the backlight device in which the insulation case and the elastic member are assembled to form a vacuum chamber.

FIG. 5 is a cross-sectional view of a backlight device according to a second exemplary embodiment of the present invention.

FIG. 6 is an exploded perspective view of an insulation case and an elastic member shown in FIG. 5.

FIG. 7 is a side-view of the elastic member that is not yet assembled to the vacuum chamber and the elastic member that is assembled to the vacuum chamber.

FIG. 8 is a cross-sectional view of a backlight device according to a third exemplary embodiment of the present invention.

FIG. 9 is a perspective view of an elastic member shown in FIG. 8.

FIG. 10 is an exploded perspective view of a display device according to an exemplary embodiment of the present invention.

FIG. 11 is a cross-sectional view of a display panel shown in FIG. 10.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

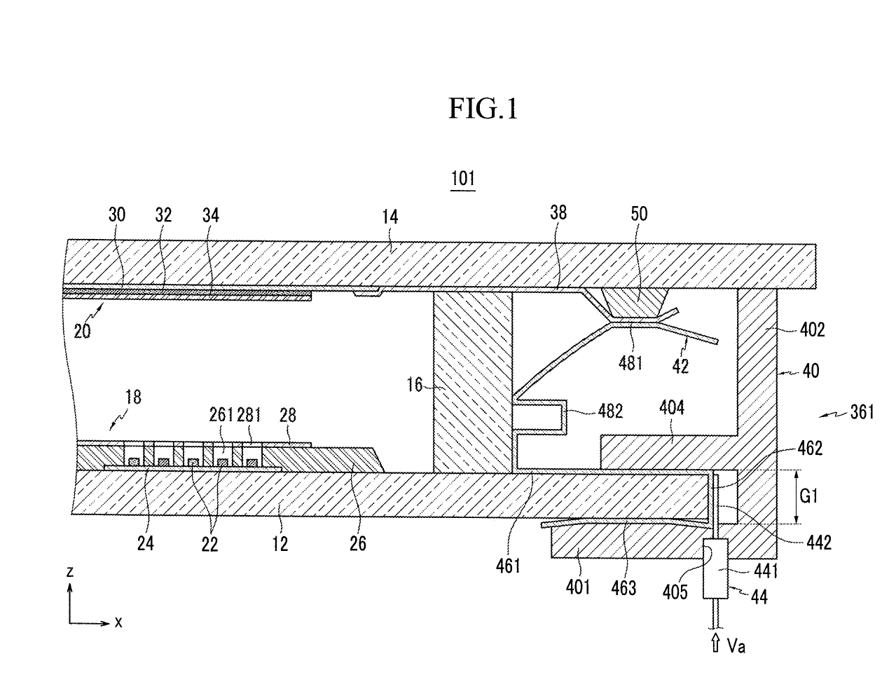

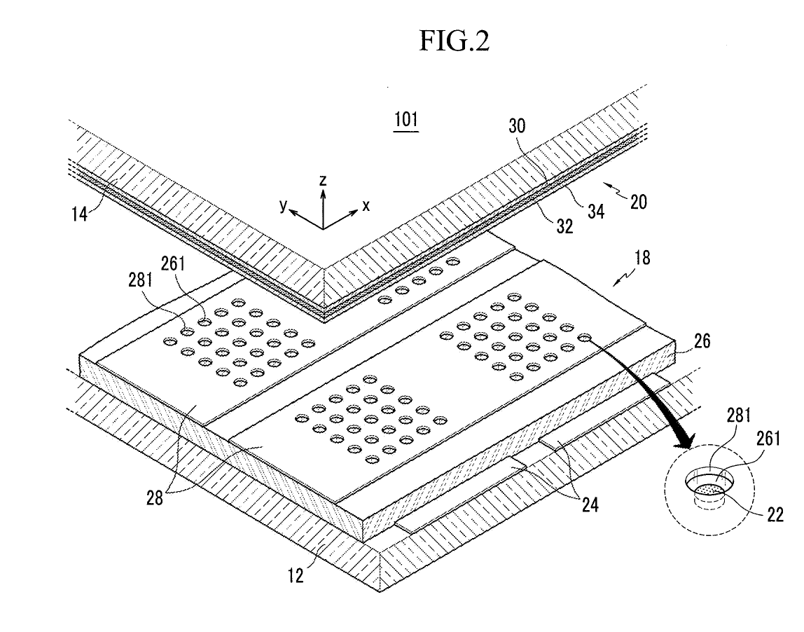

A backlight device according to a first exemplary embodiment of the present invention will be described with reference to FIG. 1 and FIG. 2.

As shown in FIG. 1 and FIG. 2, a backlight device 101 according to the first exemplary embodiment of the present invention includes a vacuum chamber. The vacuum chamber includes a first substrate 12 and a second substrate 14 that are arranged opposite to each other, and a sealing member 16 that is disposed between the first substrate 12 and the second substrate 14 to attach the substrates 12 and 14 together. An interior of the vacuum chamber is evacuated to a degree of vacuum of about 10⁻⁶ Torr.

Inside the vacuum chamber sealed by the sealing member 16, the first and second substrates 12 and 14 may be divided into an active area at which visible light is substantially emitted, and an inactive area surrounding the active area. An electron emission unit 18 including a plurality of electron emission elements is located at the active area on an inner surface of the first substrate 12, and a light emission unit 20 is located at the active area on an inner surface of the second substrate 14.

The second substrate 14 on which the light emission unit 20 is located may be a front substrate of the backlight device 101, and the first substrate 12 on which the electron emission unit 18 is located may be a rear substrate of the backlight device 101.

The electron emission unit 18 includes electron emission regions 22 and driving electrodes for controlling an amount of emission currents of the electron emission regions 22. The driving electrodes include cathode electrodes 24 formed in a stripe pattern along a direction (i.e., a y-axis direction shown in FIG. 2) of the first substrate 12, gate electrodes 28 formed in a stripe pattern along a direction (i.e., an x-axis direction shown in FIG. 2) crossing the cathode electrodes 24, and an insulation layer 26 between the cathode electrodes 24 and the gate electrodes 28.

Openings 281 and 261 are formed respectively in the gate electrode 28 and the insulation layer 26 at crossing regions between the cathode and gate electrodes 24 and 28, thereby partly exposing surfaces of the cathode electrodes 24, and the electron emission regions 22 are positioned on the cathode electrodes 24 in the openings 261 of the insulation layer 26.

The electron emission regions 22 are formed of a material that can emit electrons when an electric field is applied under a vacuum. For example, the electron emission regions 22 may be formed of a carbon-based material or a nanometer-sized material. In addition, the electron emission regions 22 may be formed of a material selected from carbon nanotubes, graphite, graphite nanofibers, diamond, diamond-like carbon, fullerene (C₆₀), silicon nanowires, and/or combinations thereof.

Alternatively, the electron emission regions 22 each may be formed as a structure having a sharp tip and utilizing a material such as molybdenum (Mo) or silicon (Si).

In the above configuration, one cathode electrode 24, one gate electrode 28, and the electron emission regions 22 positioned at a crossing region between the cathode and gate electrodes 24 and 28 may form one electron emission element. The one electron emission element may be positioned on one pixel area of the backlight device 101, or a plurality of electron emission elements may be positioned on one pixel area of the backlight device 101.

The light emission unit 20 includes an anode electrode 30, a phosphor layer 32 positioned on one surface of the anode electrode 30, and a reflective layer 34 covering the phosphor layer 32.

The anode electrode 30 is formed of a transparent conductive material such as indium tin oxide (ITO) so as to transmit visible light emitted from the phosphor layer 32. The anode electrode 30, which is an acceleration electrode for attracting electron beams, receives a positive direct current (DC) voltage (e.g., anode voltage) higher than several thousand volts to maintain the phosphor layer 32 in a high potential state.

The phosphor layer 32 may be made of a mixed phosphor of red, green, and blue phosphors to collectively emit white light. The phosphor layer 32 may be disposed on the entire active area of the second substrate 14 or may be disposed in multiple separated areas for each pixel area. In FIG. 1 and FIG. 2, it is illustrated that the phosphor layer 32 is disposed on the entire active area of the second substrate 14.

The reflective layer 34 may be formed of a thin aluminum film of a thickness about several thousand Å, and includes tiny holes for transmitting the electrons. The reflective layer 34 reflects visible light, which is emitted toward the first substrate 12 among the visible lights emitted from the phosphor layer 32, back to the second substrate 14 to increase luminance of the backlight device 101. In some embodiments, the anode electrode 30 may not be provided. Instead, the reflective layer 34 may receive the anode voltage to function as the anode electrode.

Spacers (not shown) for supporting the vacuum chamber against implosion and maintaining a gap between the substrates 12 and 14 are disposed between the first substrate 12 and the second substrate 14. The first substrate 12 and the second substrate 14 may have a gap of 5 to 20 mm therebetween, and the anode electrode 30 may receive a high voltage greater than 10 kV (e.g., approximately 10 to 15 kV).

In addition, while a field emission array (FEA) type electron emission element has been described, the electron emission element is not limited to the FEA type, and the electron emission element may be a surface-conduction emission (SCE) device, a metal-insulator-metal (MIM) device, or a metal-insulator-semiconductor (MIS) device.

The above backlight device 101 applies a scan driving voltage to either of the cathode electrodes 24 or the gate electrodes 28, applies a data driving voltage to the other electrodes, and applies the anode voltage that is greater than several thousand volts to the anode electrode 30.

Thereby, electric fields are formed around the electron emission regions 22 in pixels where a voltage difference between the cathode electrode 24 and the gate electrode 28 is greater than a threshold value, and electrons are emitted therefrom. The emitted electrons are attracted by the anode voltage applied to the anode electrode 30 to collide with the corresponding phosphor layer 32, thereby emitting light.

In the first exemplary embodiment of the present invention, the anode electrode 30 receives an anode voltage Va from a power source unit outside the vacuum chamber through a voltage applying unit 361 to accelerate the electrons.

The voltage applying unit 361 includes a lead wire 38 that is electrically connected to the anode electrode 30 and partially exposed to the outside of the vacuum chamber, an insulation case 40 located at the outside of the vacuum chamber to shield the lead wire 38, an elastic member 42 inside the insulation case 40, and an anode connector 44 penetrating into the insulation case 40 to contact the elastic member 42. The elastic member 42 is partially connected to the lead wire 38 and fixed between the first substrate 12 and the second substrate 14 by using elastic force.

The lead wire 38 is provided on an inner surface of the second substrate 14 and crosses the sealing member 16. An end of the lead wire 38 positioned inside the vacuum chamber contacts the anode electrode 30 to be electrically connected thereto. The insulation case 40 is formed of insulation materials such as rubber, plastic, or a high polymer resin, and may be elastic. The elastic member 42 is, for example, a type of leaf spring and is formed of metal to have conductivity.

The backlight device 101 may include one lead wire 38, or it may include a plurality of lead wires 38. When the backlight device 101 includes a plurality of lead wires 38, the insulation case 40, the elastic member 42, and the anode connector 44 are provided to each lead wire 38.

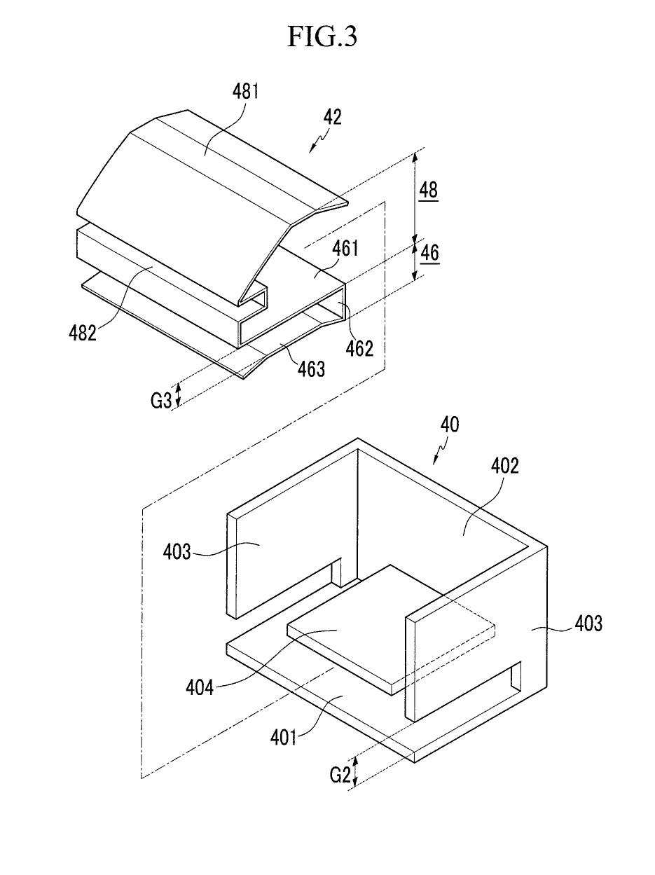

FIG. 3 is an exploded perspective view of the insulation case 40 and the elastic member 42 shown in FIG. 1.

As shown in FIG. 1 and FIG. 3, the insulation case 40 includes a bottom portion 401 facing an outer surface of the first substrate 12, a first wall portion 402 extending toward the second substrate 14 from an edge of the bottom portion 401 that is positioned at the farthest distance from the sealing member 16, a pair of second side wall portions 403 extending toward the sealing member 16 from left and right edges of the first side wall portion 402, and a guide portion 404 positioned in parallel with the bottom portion 401 to extend toward the sealing member 16 from an inside surface of the first side wall portion 402.

Since a portion of the first substrate 12 is between the bottom portion 401 and the guide portion 404, a gap G1 (referring to FIG. 1) between the bottom portion 401 and the guide portion 404 is slightly larger than the thickness of the first substrate 12.

In addition, since a portion of the first substrate 12 is between the second side wall portions 403 and the bottom portion 401, a gap G2 (referring to FIG. 3) is formed between the bottom portion 401 and a front part of each of the second side wall portions 403. The gap G2 between the second side wall portions 403 and the bottom portion 401 is larger than the thickness of the first substrate 12.

In addition, the anode connector 44 penetrates the bottom portion 401 through an opening 405 (referring to FIG. 1). The opening 405 is below the guide portion 404 and at a suitable distance from the first side wall portion 402.

When a portion of the first substrate 12 is positioned between the guide portion 404 and the bottom portion 401, and between the second side wall portions 403 and the bottom portion 401, the bottom portion 401 surrounds a lower part of the elastic member 42, and the first side wall portion 402 and the pair of second side wall portions 403 surround rear, left, and right surfaces of the elastic member 42 and the lead wire 38. Accordingly, the insulation case 40 shields the lead wire 38 and the elastic member 42 so that the lead wire 38 and the elastic member 42 are not exposed to the outside of the backlight device 101.

The elastic member 42 includes a first elastic portion 46 for attaching and fixing the elastic member 42 to the first substrate 12, and a second elastic portion 48 inserted between the first substrate 12 and the second substrate 14 to be fixed (or secured) between the substrates 12 and 14 while contacting the lead wire 38.

The first elastic portion 46 includes a first horizontal portion 461 for contacting an inner surface of the first substrate 12, a vertical portion 462 contacting a side surface of the first substrate 12, and a second horizontal portion 463 contacting an outer surface of the first substrate 12. A gap G3 (referring to FIG. 3) between the first horizontal portion 461 and the second horizontal portion 463 is formed to have a less thickness than that of the first substrate 12, and the first substrate 12 is inserted thereto while the first elastic portion 46 is temporarily widened to accept the first substrate 12.

The second elastic portion 48 includes a contact portion 481 for contacting the lead wire 38, and a connecting portion 482 for contacting an outer surface of the sealing member 16 and connecting the contact portion 481 to the first elastic portion 46. The contact portion 481 may be formed in a circular arc shape having a suitable curvature, and a part of the connecting portion 482 may protrude toward the outside of the vacuum chamber. The second elastic portion 48 is compressed between the first substrate 12 and the second substrate 14 to apply a force pushing the substrates 12 and 14 away from each other.

In addition, an insulation mound 50 having a suitable height (e.g., a predetermined height) is formed on an inner surface of the second substrate 14 outside the vacuum chamber to bias a portion of the lead wire 38 away from the second substrate 14 and protrude toward the first substrate 12. Accordingly, the insulation mound 50 pushes the lead wire 38 toward the elastic member 42 to increase contact strength of the lead wire 38 and the elastic member 42, and further compresses the second elastic portion 48, thereby increasing the elastic force of the second elastic portion 48 and the lead wire 38.

The elastic member 42 may be fixed on the insulation case 40. That is, a part of the elastic member 42 is fixed on the insulation case 40 by using a fixing agent. For example, an upper surface of the first horizontal portion 461 may be fixed to a lower surface of the guide portion 404 by using the fixing agent.

The anode connector 44 is inserted into the opening 405 of the bottom portion 401 of the insulation case 40 to penetrate through the bottom portion 401. The anode connector 44 may include an insulative supporting portion 441 and a conductive wire 442 fixed to the supporting portion 441, and the conductive wire 442 contacts the vertical portion 462 of the elastic member 42 to apply the anode voltage Va to the elastic member 42.

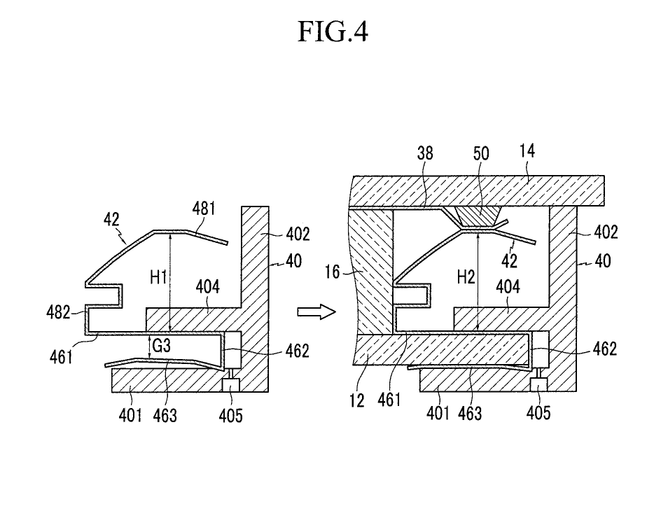

FIG. 4 is a cross-sectional view of the backlight device 101 in which the insulation case 40 and the elastic member 42 are assembled to the vacuum chamber.

As shown in FIG. 3 and FIG. 4, the gap G3 between the first horizontal portion 461 and the second horizontal portion 463 is formed to be thinner than the thickness of the first substrate 12 before it is assembled to the vacuum chamber, and the second elastic portion 48 is formed with a maximum height H1 (i.e., not compressed).

In an assembling process of the vacuum chamber, the gap G3 is widened when the first substrate 12 is inserted to the first elastic portion 46. Since the gap G3 is originally smaller than the thickness of the first substrate 12, it forms a compression fit between the first elastic portion 46 and the first substrate 12 so as to secure the first substrate 12 to the first elastic portion 46 when assembled.

The second elastic portion 48 is compressed while being inserted between the first substrate 12 and the second substrate 14. That is, the second elastic portion 48 having an initial height H1 is compressed to have a height H2 that is less than H1, and applies the repulsive force to the first substrate 12 and the second substrate 14. Accordingly, the second elastic portion 48 is tightly secured between the first substrate 12 and the second substrate 14.

Here, since the elastic member 42 and the insulation case 40 are combined with each other, the insulation case 40 is tightly combined with the vacuum chamber by securing the elastic member 42 to the vacuum chamber. Then, the anode connector 44 shown in FIG. 1 is inserted into the opening 405 of the insulation case 40 to contact the conductive wire 442 shown in FIG. 1 to the elastic member 42, and therefore the anode voltage Va is applied to the anode electrode 30 through the elastic member 42 and the lead wire 38.

In the first exemplary embodiment of the present invention, the elastic member 42 fixes the insulation case 40 to the vacuum chamber, and functions as a connector for transmitting the anode voltage. The voltage applying unit 361 efficiently shields the lead wire 38 from being exposed to the outside of the backlight device 101. The elastic member 42, the insulation case 40, and the anode connector 44 are stably combined with the lead wire 38.

The above voltage applying unit 361 may be easily applied when a protrusion part of the first substrate 12 that is protruded toward the outside of the vacuum chamber has a sufficient width.

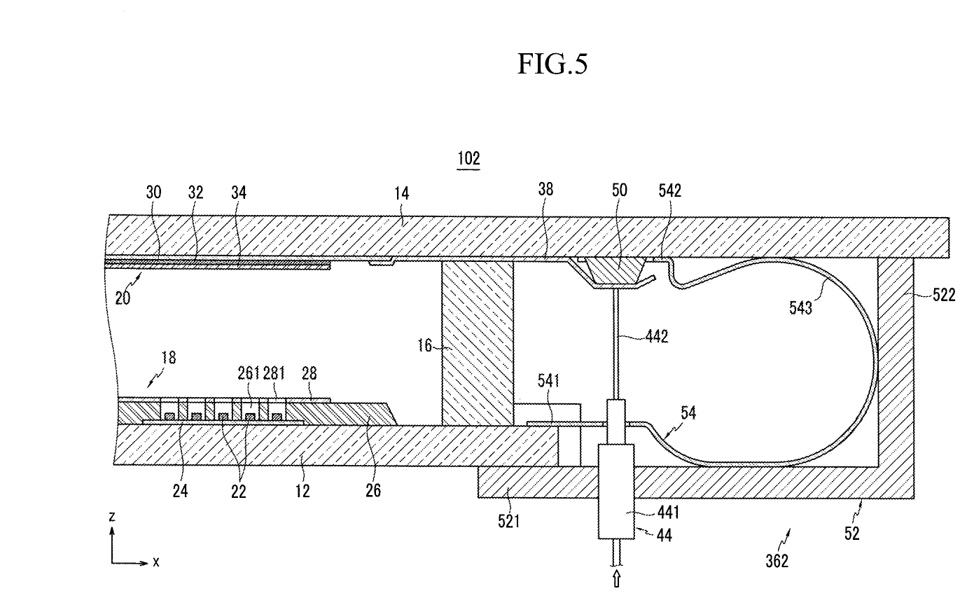

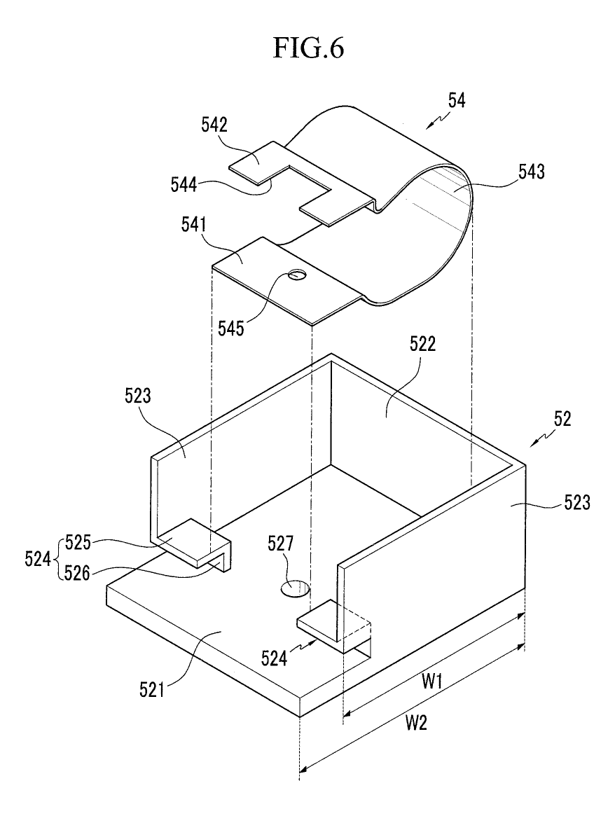

A backlight device according to a second exemplary embodiment of the present invention will now be described with reference to FIG. 5 and FIG. 6.

As shown in FIG. 5 and FIG. 6, a backlight device 102 according to the second exemplary embodiment of the present invention is substantially the same as that of the first exemplary embodiment of the present invention except for a configuration of a voltage applying unit 362. Like reference numerals are used for like elements of the first exemplary embodiment.

In the second exemplary embodiment of the present invention, the voltage applying unit 362 includes the lead wire 38, an insulation case 52 positioned on the outside of the vacuum chamber to shield the lead wire 38, an elastic member 54 provided in the insulation case 52 and fixed between the first substrate 12 and the second substrate 14 by using the elastic force, and the anode connector 44 penetrated through the insulation case 52 to contact the lead wire 38.

The insulation case 52 includes a bottom portion 521 facing the outer surface of the first substrate 12, a first side wall portion 522 extending toward the second substrate 14 from an edge of the bottom portion 521 that is positioned at the farthest distance from the sealing member 16, a pair of second side wall portions 523 extending toward the sealing member 16 from left and right edges of the first side wall portion 522, and a pair of guide portions 524 provided in the second side wall portions 523.

A width W1 (referring to FIG. 6) of each of the second side wall portions 523 is less than a width W2 (referring to FIG. 6) of the bottom portion 521. Since a portion of the first substrate 12 is inserted between the second side wall portions 523 and the bottom portion 521, the second side wall portions each 523 form a gap (e.g., a predetermined gap) from the bottom portion 521 on a front part of the sealing member 16. The gap between either of the second side wall portions 523 and the bottom portion 521 is formed to be larger than the thickness of the first substrate 12.

The guide portions 524 each include a first guide surface 525 positioned in parallel to the bottom portion 521 to contact an inner surface of the first substrate 12, and a second guide surface 526 positioned perpendicular to the bottom portion 521 to contact a side surface of the first substrate 12. Thereby, an edge of the first substrate 12 is inserted between the bottom portion 521 and the pair of guide portions 524.

The elastic member 54 includes a first supporting portion 541 for contacting the inner surface of the first substrate 12, a second supporting portion 542 for contacting the inner surface of the second substrate 14, and an elastic portion 543 connecting the first supporting portion 541 and the second supporting portion 542. The first supporting portion 541, the second supporting portion 542, and the elastic portion 543 have the same widths.

The first supporting portion 541 is provided between the pair of guide portions 524, and the first supporting portion 541 contacts the inner surface of the first substrate 12 when a portion of the first substrate 12 is inserted between the guide portions 524 and the bottom portion 521. The second supporting portion 542 includes a cut-out portion 544 where the insulation mound 50 and the lead wire 38 are positioned, and the second supporting portion 542 is positioned at a suitable distance (e.g., a predetermined distance) from the insulation mound 50. The elastic portion 543 may be formed in a semi-circular shape having a suitable curvature (e.g., a predetermined curvature).

The elastic member 54 may be fixed on the insulation case 52 by using a fixing agent. For example, a lower surface of the elastic portion 543 may be fixed on an upper surface of the bottom portion 521.

The anode connector 44 penetrates the insulation case 52 and the elastic member 54 through the openings 527 and 545 respectively provided on the bottom portion 521 of the insulation case 52 and the first supporting portion 541 of the elastic member 54. The anode connector 44 may include the insulative supporting portion 441 and the conductive wire 442 fixed on the supporting portion 441, and the conductive wire 442 contacts the lead wire 38 to apply the anode voltage Va to the anode electrode 30 through the lead wire 38.

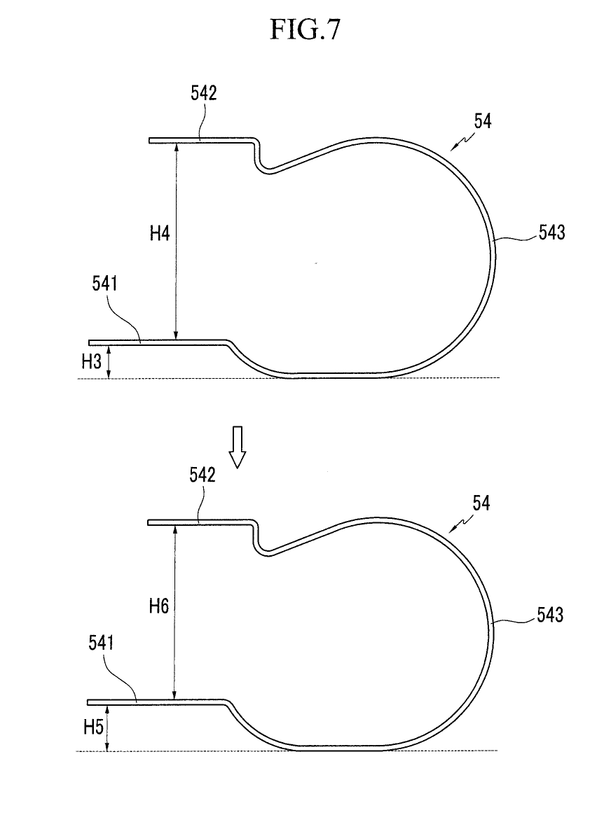

FIG. 7 is a side-view of the elastic member 54 that is not yet assembled to the vacuum chamber and the elastic member that is assembled to the vacuum chamber.

As shown in FIG. 7, before the elastic member 54 is assembled to the vacuum chamber, a height between the first supporting portion 541 and the bottom portion 521 of the insulation case 52 is H3, and a height between the first supporting portion 541 and the second supporting portion 542 is H4. Here, the height H4 between the first supporting portion 541 and the second supporting portion 542 is greater than a height of the sealing member 16.

While the elastic member 54 is assembled to the vacuum chamber, the first supporting portion 541 rises toward the second supporting portion 542 since the first substrate 12 is provided under the first supporting portion 541, and a height between the first supporting portion 541 and the second supporting portion 542 is reduced since the elastic portion 543 is compressed. Therefore, the elastic member 54 applies a repulsive force on the first substrate 12 and the second substrate 14 to be tightly combined with the first substrate 12 and the second substrate 14.

In FIG. 7, H5 denotes a height between the first supporting portion 541 and the bottom portion 521 of the insulation case 52, and H6 denotes a height between the first supporting portion 541 and the second supporting portion 542 after the elastic member 54 is assembled to the vacuum chamber.

Here, the elastic member 54 and the insulation case 52 may be combined with each other, and the insulation case 52 is tightly secured to the vacuum chamber by securing the elastic member 54 to the vacuum chamber.

As described above, when a portion of the first substrate 12 is inserted between the bottom portion 521 and the guide portions 524, and the elastic member 54 is secured to the vacuum chamber, the bottom portion 521 surrounds a lower part of the elastic member 54, and the first side wall portion 522 and the pair of second side wall portions 523 surround rear, left, and right surfaces of the elastic member 52 and the lead wire 38. Therefore, the insulation case 52 shields the lead wire 38 and the elastic member 54 so that the lead wire 38 and the elastic member 54 are not exposed to the outside of the backlight device.

In the second exemplary embodiment of the present invention, the elastic member 54 fixes the vacuum chamber to the insulation case 52, and the anode connector 44 contacts the lead wire 38 to apply the anode voltage Va to the lead wire 38. The voltage applying unit 362 effectively shields the lead wire 38 from being exposed to the outside of the backlight unit, and the connection between the lead wire 38 and the anode connector 44 may be further stably secured by providing the elastic member 54, the insulation case 52, and the anode connector 44.

The above voltage applying unit 362 may be easily applied when a protrusion part of the first substrate 12 that is protruded toward the outside of the sealing member 16 has a lesser width.

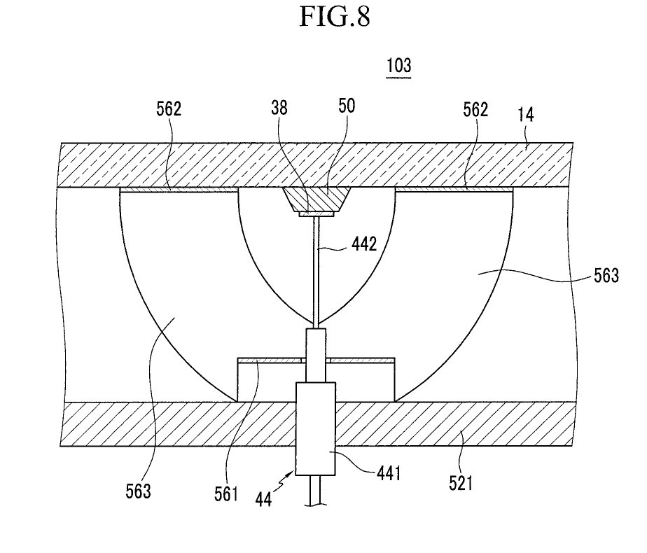

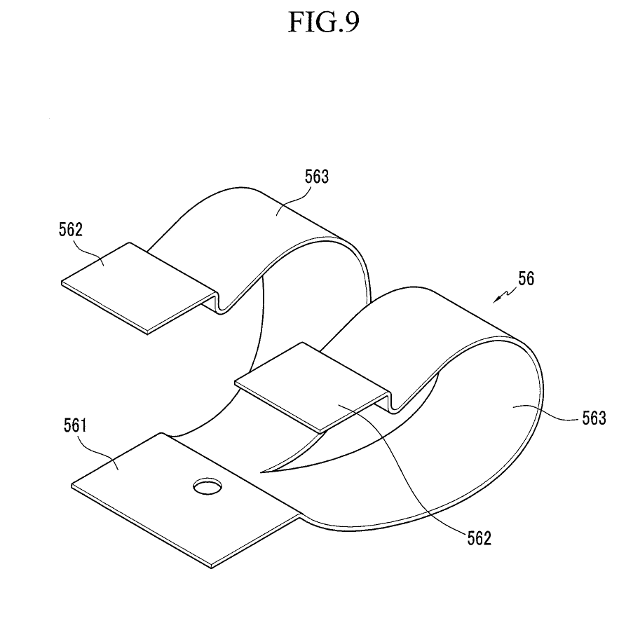

A backlight device according to a third exemplary embodiment of the present invention will now be described with reference to FIG. 8 and FIG. 9.

As shown in FIG. 8 and FIG. 9, a backlight device 103 according to the third exemplary embodiment of the present invention is substantially the same as that of the second exemplary embodiment of the present invention except for an elastic member 56. Like reference numerals are used for like elements of the second exemplary embodiment.

The elastic member 56 according to the third exemplary embodiment includes a first supporting portion 561 for contacting the outer surface of the first substrate 12, a pair of second supporting portions 562 that are positioned at a distance from each other and contact the inner surface of the second substrate 14, and a pair of elastic portions 563 that are separately formed from each other and connect the first supporting portion 561 and the second supporting portions 562. The insulation mound 50 and the lead wire 38 are provided between the pair of second supporting portions 562.

Compared to the elastic member 54 according to the second exemplary embodiment of the present invention, a contact area between the second supporting portions 562 and the second substrate 14 is increased, therefore a force securing the elastic member 56 may be enhanced.

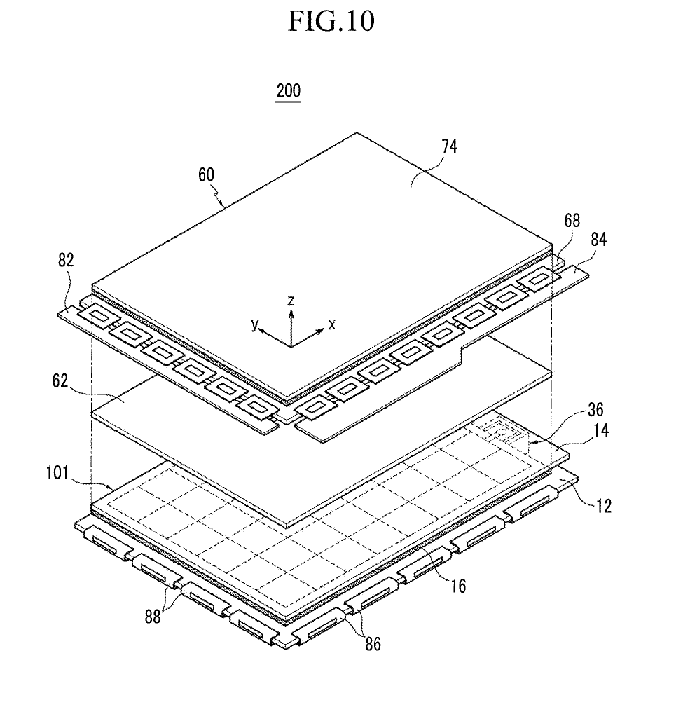

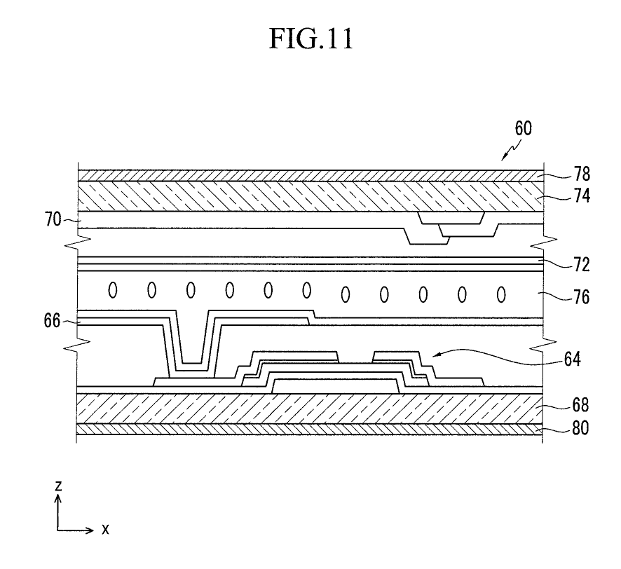

FIG. 10 is an exploded perspective view of a display device according to an exemplary embodiment of the present invention, and FIG. 11 is a cross-sectional view of the display panel shown in FIG. 10.

A display device 200 according to the exemplary embodiment of the present invention includes a backlight device according to one of the first to third exemplary embodiments of the present invention, and it is illustrated in FIG. 10 with a backlight device according to the first exemplary embodiment of the present invention.

As shown in FIG. 10, the display device 200 according to the exemplary embodiment of the present invention includes a backlight device 101, and a display panel 60 provided in front of the backlight device 101. A light diffuser 62 for evenly diffusing light emitted from the backlight device 101 may be provided between the backlight device 101 and the display panel 60, and the light diffuser 62 and the backlight device 101 are positioned at a suitable distance (e.g., a predetermined distance) from each other.

The display panel 60 can be a liquid crystal display panel or other passive display panels. By way of example, the display panel 60 illustrated as the liquid crystal display panel will now be described.

As shown in FIG. 11, the display panel 60 includes a lower substrate 68 on which thin film transistors (TFTs) 64 and pixel electrodes 66 are formed, an upper substrate 74 on which a color filter layer 70 and a common electrode 72 are formed, and a liquid crystal layer 76 provided between the upper substrate 74 and the lower substrate 68. Polarizing plates 78 and 80 are respectively provided on an upper surface of the upper substrate 74 and a lower surface of the lower substrate 68 to polarize the light transmitted through the display panel 60.

The pixel electrode 66 is positioned in each sub-pixel, and is controlled by the TFT 64. The pixel electrodes 66 and the common electrode 72 are formed of transparent materials. The color filter layer 70 includes a red filter layer, a green filter layer, and a blue filter layer per each sub-pixel.

When a TFT 64 of a sub-pixel is turned on, an electric field is formed between the pixel electrode 66 and the common electrode 72, and the arrangement angles of liquid crystal particles change according to the electric field. Therefore, the light transmittance varies with the changed arrangement angles. The luminance and emitting color of each pixel of the display panel 60 can be controlled through this process described above.

In FIG. 10, reference numeral 82 denotes a gate circuit board assembly for transmitting a gate driving signal to a gate electrode of each TFT 64, and reference numeral 84 denotes a data circuit board assembly for transmitting a data driving signal to the source electrode of each TFT 64.

Referring to FIG. 10, the backlight device 101 includes less pixels than the display panel 60 so as to correspond one pixel of the backlight device 101 to two or more pixels of the display panel 60. Each pixel of the backlight device 101 can emit light corresponding to the highest graylevel among a plurality of pixels of the display panel 60, and can express 2 to 8 bits of graylevels.

For convenience, a pixel of the display panel 60 is referred to as a first pixel, and a pixel of the backlight device 101 is referred to as a second pixel. The first pixels corresponding to one second pixel is referred to as a first pixel group.

A method for driving the backlight device 101 may include \textcircled{1} detecting the highest graylevel among the first pixels of the first pixel group by a signal controller (not shown) controlling the display panel 60, \textcircled{2} calculating a graylevel for the second pixel to emit light according to the detected graylevel and transforming the calculated graylevel to digital data, \textcircled{3} generating a driving signal of the backlight device 101 using the digital data, and \textcircled{4} applying the generated driving signal to the driving electrodes of the backlight device 101.

The driving signal of the backlight device 101 includes a scan driving signal and a data driving signal. The cathode electrodes or the gate electrodes receive the scan driving signal, and the other electrodes receive the data driving signal.

A scan circuit board assembly and a data circuit board assembly may be disposed at a rear surface of the backlight device 101 for driving the backlight device 101. In FIG. 10, reference numeral 86 denotes the first connectors for connecting the cathode electrodes and the data circuit board assembly, and reference numeral 88 denotes the second connectors for connecting the gate electrodes and the scan circuit board assembly. In addition, a voltage applying unit 36 for applying the anode voltage Va is disposed at an edge of the backlight device 101.

The second pixel of the backlight device 101 is synchronized with the first pixel group and emits light at a suitable graylevel (e.g., a predetermined graylevel) when an image is displayed on the corresponding first pixel group. That is, the backlight device 101 provides light with a high luminance to a bright area of the display panel 60 and provides light with a low luminance to a dark area of the display panel 60. Accordingly, the display device 200 according to the exemplary embodiment of the present invention can increase a contrast ratio of the screen and provide a sharper image quality.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display panel for displaying an image and a backlight device for providing light toward the display panel, the backlight device comprising:
a first substrate and a second substrate facing the first substrate;
a sealing member between the first substrate and the second substrate, a space enclosed by the sealing member, the first substrate and the second substrate being a vacuum chamber;
an electron emission unit on an inner surface of the first substrate;
a light emission unit on an inner surface of the second substrate and comprising an anode electrode; and
a voltage applying unit for applying an anode voltage to the anode electrode,
the voltage applying unit comprising:
a lead wire connected to the anode electrode and partially outside the vacuum chamber,
an insulation case for shielding a portion of the lead wire outside the vacuum chamber,
an elastic member in the insulation case for securing the insulation case to the vacuum chamber by using elastic force, and
an anode connector extending through the insulation case for applying the anode voltage to the lead wire.

2. The display device of claim 1, wherein an insulation mound, on the inner surface of the second substrate outside of the vacuum chamber, biases the lead wire toward the first substrate.

3. The display device of claim 1, wherein the anode connector and the lead wire are electrically connected to each other by the elastic member.

4. The display device of claim 3, wherein the elastic member comprises a first elastic portion for receiving a portion of the first substrate and contacting the anode connector, and a second elastic portion between the first and second substrates for contacting the lead wire.

5. The display device of claim 4,
wherein the first elastic portion comprises a first horizontal portion and a second horizontal portion in parallel to each other and a vertical portion for connecting the first horizontal portion and the second horizontal portion,
wherein the first elastic portion is configured such that a gap between the first and second horizontal portions have a width that is less than a thickness of the first substrate before the first substrate is assembled with the first elastic portion, and
wherein the second elastic portion comprises a contact portion for contacting the lead wire and a connecting portion for connecting the contact portion to the first elastic portion, and the second elastic portion is compressed between the first and second substrates.

6. The display device of claim 4, wherein the insulation case comprises
a bottom portion facing an outer surface of the first substrate, a first side wall portion extending from an edge of the bottom portion toward the second substrate,
a pair of second side wall portions respectively extending from a left edge and a right edge of the first side wall portion toward the sealing member, and
a guide portion extending from an inner surface of the first side wall portion toward the sealing member.

7. The display device of claim 6, wherein the first elastic portion is between the bottom portion and the guide portion, and the first elastic portion is fixed to the insulation case.

8. The display device of claim 7, wherein the bottom portion comprises an opening, and the anode connector extends through the opening to contact the vertical portion of the first elastic portion.

9. The display device of claim 1, wherein the anode connector contacts the lead wire.

10. The display device of claim 9, wherein the elastic member comprises
a first supporting portion contacting the inner surface of the first substrate,
a second supporting portion contacting the inner surface of the second substrate,
an elastic portion connecting the first supporting portion and the second supporting portion, and
an opening within the first supporting portion, wherein the anode connector extends through the opening.

11. The display device of claim 10, wherein the insulation case comprises
a bottom portion partially facing an outer surface of the first substrate and comprising an opening, wherein the anode connector extends through the opening,
a first side wall portion extending from an edge of the bottom portion to the second substrate,
a pair of second side wall portions respectively extending from left and right edges of the first side wall portions toward the sealing member, and
a pair of guide portions, one each on each of the second side wall portions, and proximate to edges of the second side wall portions opposite to edges of the second said wall portions meeting the first side wall portion.

12. The display device of claim 11, wherein each of the guide portions comprises a first guide surface for contacting the inner surface of the first substrate and a second guide surface for contacting a side surface of the first substrate.

13. The display device of claim 11, wherein the first supporting portion is between the pair of guide portions, and the first supporting portion is configured to contact the inner surface of the first substrate when the first substrate is positioned between the pair of facing guide portions and the bottom portion.

14. The display device of claim 9, wherein the elastic member comprises
a first supporting portion for contacting the inner surface of the first substrate,
a pair of second supporting portions for contacting the inner surface of the second substrate and positioned at a distance from each other, and
a pair of elastic portions connecting the first supporting portion and the second supporting portions, wherein the first supporting portion has an opening, and the anode connector extends through the opening.

15. The display device of claim 1,
wherein the display panel comprises a plurality of first pixels,
wherein the backlight device further comprises a plurality of second pixels less in number than the plurality of first pixels, and the plurality of second pixels each are configured to emit light corresponding to a highest graylevel among graylevels of the corresponding first pixels of the plurality of first pixels.

16. The display device of claim 1, wherein the display panel comprises a liquid crystal display panel.
